(19) United States
(12) Patent Application Publication
(10) Pub. No.: US 2002/0069047 A1
(43) Pub. Date: Jun. 6, 2002

(54) Computer-aided language learning method and system

(76) Inventors: Pinky Ma, Beijing (CN); Zechary Chang, Taipei (TW); Sayling Wen, Taipei (TW)

Correspondence Address: BIRCH STEWART KOLASCH & BIRCH, PO BOX 747, FALLS CHURCH, VA, 22040-0747, US

(21) Appl. No.: 09/729,417

(22) Filed: Dec. 5, 2000

(51) Int. Cl. G06F 17/28

(52) U.S. Cl. 704/2

(57) ABSTRACT

A computer-aided language method, comprising a sentence reading procedure, a sentence partition procedure, a recombination output procedure, an input acceptance procedure, a sentence comparison procedure and a result output procedure. In the sentence reading procedure, a first language sentence is read from a sentence database readable by a computer and a second language sentence corresponding to the first language sentence. The sentence partition procedure performs elementary partitions on the first language sentence so as to obtain a plurality of sentence elements. The recombination procedure performs a recombination sub-procedure on the sentence elements and outputs the result to a learner. The input acceptance procedure accepts the data entered by the leaner regarding the result of the recombination sub-procedure. When the entered data is a learner-input sentence, the sentence comparison procedure performs the comparison between the learner-input sentence and the first language sentence. The result output procedure then outputs the comparison result between the learner-input sentence and the first language sentence to the learner. The invention also discloses a corresponding computer-aided language learning system.

### BACKGROUND OF THE INVENTION

1. Field of Invention

The invention relates to a computer-aided language learning method and the corresponding system and, in particular, to a computer-aided language learning method and the corresponding system that can provide integrated vocabulary, grammar and phonetics practice so as to effectively enhance the learner's comprehension and expression abilities.

2. Related Art

According to a widely accepted theory in modem linguistics, the composition of a sentence consists of vocabulary, grammar and phonetics. The ultimate goal of language learning is to master these three parts to equip one with the ability to correctly understand the semantics and to freely create and express all types of information.

In the past, most language courses were designed for test taking purposes, therefore the contents of the course focused mainly on the instruction of knowledge related to the mechanics of the language and not on the improvement of comprehension or expression. Under such a teaching model, vocabulary, grammar and phonetics are usually separately studied in the learning procedure. That is, students first learn vocabulary then phonetics and finally grammar. The comprehension of a full sentence is the last area of study. Since this language learning method is not good for mastering a language, most learners cannot communicate with other people using the language even after several years of study.

In recent years, along with the progress in computer technology, many manufacturers have developed language-learning materials using computers as auxiliary tools. However, most of them simply provide a large amount of content or test problem databases to help learners' practice. They do not improve the learning method by utilizing some characteristic features of the computer. In other words, they do not fully use the high potential for interactivity between a computer and a learner that a computer offers. Therefore, they cannot learn vocabulary, grammar and phonetics in an integrated environment.

Therefore, how to utilize mature computer technology to implement more efficient language teaching and to improve the language ability of a learner has become an important subject to be solved.

### SUMMARY OF THE INVENTION

In view of the above, it is an object of the invention to provide a computer-aided language learning method, which during language teaching can provide an integrated practice environment for vocabulary, grammar and phonetics so as to efficiently increase the comprehension and expression abilities of a learner.

Another object of the invention is to provide a computer-aided language learning method in which the syntax practice is progressive and thereby enhance the efficiency of the learning process.

To achieve the above objects, the computer-aided language method according to the invention comprises a sentence reading procedure, a sentence partition procedure, a recombination output procedure, an input acceptance procedure, a sentence comparison procedure and a result output procedure. In the sentence reading procedure, a first language sentence is read from a sentence database readable by a computer and a second language sentence corresponding to the first language sentence. The sentence partition procedure performs elementary partitions on the first language sentence so as to obtain a plurality of sentence elements. The recombination procedure performs a recombination sub-procedure on the sentence elements and outputs the result to the learner. The input acceptance procedure accepts the data entered by the leaner using the results of the recombination sub-procedure. When the entered data is the input sentence of the learner, the sentence comparison procedure performs a comparison between the learner-input sentence and the first language sentence. The output procedure result then outputs the comparison result between the learner-input sentence and the first language sentence to the learner.

### BRIEF DESCRIPTION OF THE DRAWINGS

The invention will become more fully understood from the detailed description given in the below illustrations, and thus are not limitative of the invention, and wherein:

FIG. 1 is a flow chart showing the procedure of the computer-aided language learning method according to a preferred embodiment of the invention;

FIG. 2 is a schematic view showing the structure of the computer-aided language learning system according to a preferred embodiment of the invention; and

FIGS. 3(A) through 3(F) are schematic views showing an example of the operation of the computer-aided language learning system according to a preferred embodiment of the invention.

### DETAILED DESCRIPTION OF THE INVENTION

The computer-aided language learning method and system according to the invention will be hereinafter described in preferred embodiments with reference to the accompanying drawings. In the various drawings, the same references relate to the same elements.

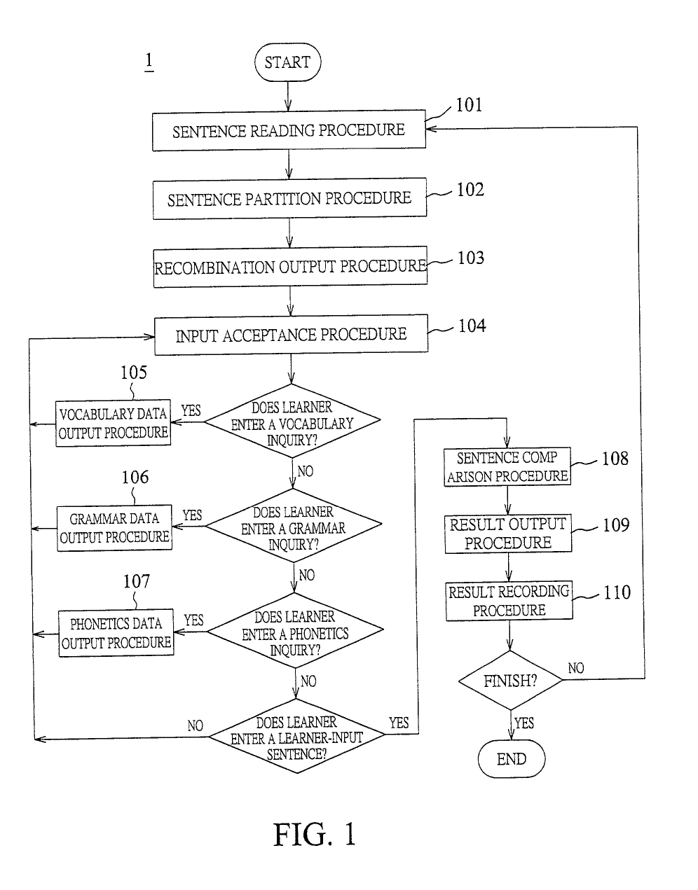

Referring to FIG. 1, the computer-aided language learning method 1 according to the preferred embodiment of the invention first performs a sentence reading procedure 101. In the sentence reading procedure 101, a first language sentence and a corresponding second language sentence are input in from a computer readable sentence database. The first language sentence is a sentence that a learner wants to learn and the second language sentence is a sentence that the learner is more familiar with. For example, for a native Chinese speaker the first language sentence may be an English sentence while the second sentence may be a Chinese sentence.

The sentence partition procedure 102 is subsequently taken to perform a sentence element partition sub-procedure on the first language sentence. The sentence element is the element used to compose a sentence, such as vocabulary, phrases or punctuation. After partitioning into sentence elements, the first language sentence becomes a combination of a plurality of sentence elements.

The recombination output procedure 103 then performs a recombination sub-procedure on the sentence elements and outputs the result to the learner. The recombination sub-procedure includes such processes as shuffling, substituting or mingling the sentence elements so as to change the original structure of the first language sentence. The shuffling process can change the order of the sentence elements; the substituting process can change the sentence elements to another structure, such as from a past tense to a present tense and the mingling process adds into the original sentence elements other sentence elements. After the processing of the recombination sub-procedure, what the learner receives is not the original first language sentence but a recombination of the sentence elements after a shuffling, substituting or mingling processes.

The method then performs the input acceptance procedure 104 to accept the data entered by the learner with regard to the combination of sentence elements processed by the recombination sub-procedure. Once the combination of sentence elements processed by the recombination sub-procedure is received, the learner can recombine the sentence elements in order to find out what the original first language sentence was and enter a learner-input sentence according to a combination that the learner thinks is correct. To increase the learning effects, the second language sentence corresponding to the first language sentence can also be output to the learner in the recombination output procedure 103 to help the learner comprehend the meaning of the first language sentence.

One should note that the learner could input the learner-input sentence through a plurality of means. For example, the learner can enter the whole learner-input sentence at one time or enter each sentence element in order by clicking on each word, phrase or punctuation element. This method can have different input methods according to the practical needs without departing from the spirit and scope of the invention.

In the input acceptance procedure 104, the learner can also enter all sorts of inquiries so as to help him determine the correct sentence element combination and to enhance the learning effects. For example, the learner can enter a vocabulary inquiry, a grammar inquiry, a phonetics inquiry or suggestion an inquiry for the whole first language sentence or for each individual sentence element. If the learner enters a vocabulary inquiry, then a vocabulary data output procedure 105 is performed so as to input the vocabulary data inquired by the learner from a computer readable vocabulary database and to output the data to the learner. If the learner enters a grammatical inquiry, then a grammar data output procedure 105 is performed so as to input the grammar data inquired by the learner from a computer readable grammar database and to output the data to the learner. If the learner enters a phonetics inquiry, then a phonetics data output procedure 107 is performed so as to input the phonetics data inquired by the learner from a computer readable phonetics database and to output the data to the learner.

After the learner-input sentence entered by the learner is received, the sentence comparison procedure 108 compares the learner-input sentence to the original first language sentence and the result is displayed in the result output procedure 109. If the comparison result indicates that the learner-input sentence is correct, then the learner is judged to understand the meaning of this sentence and to have learned the relevant vocabulary, grammar and phonetics. Therefore he can begin to practice the next sentence. Otherwise, the result output procedure 109 can also indicate the errors the learner has made and emphasize the weak points in later exercises.

In the result recording procedure 110, the learning results of each sentence done by the learner can be stored for future reference. For example, the comparison results of the learner-input sentence and the first language sentence can be stored in a statistical data table so as to determine the correctness ratio of the learner-input sentences. Or the incorrect learner-input sentences are stored for the learner to practice again. When the learner finishes practicing a certain first language sentence, he can choose to redo the practice exercise or to end the practice exercise according to practical needs.

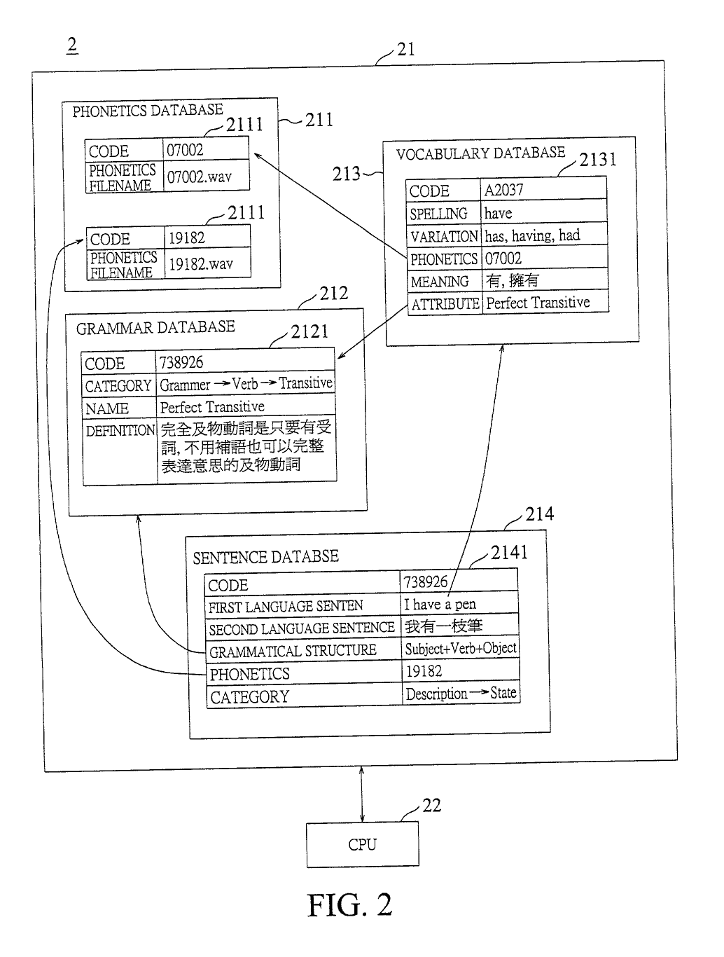

Referring to FIG. 2, the computer-aided language learning system 2 according to a preferred embodiment of the invention comprises a storage device 21 and a central processing unit (CPU) 22. The storage device 21 stores a data structure needed for performing the computer-aided language learning method 1 and comprises a phonetics database 211 that stores a plurality of phonetics data 2111, a grammar database 212 that stores a plurality of grammar data 2121, a vocabulary database 213 that stores a plurality of vocabulary data 2131 and a sentence database 214 that stores a plurality of sentence data 2141. Each of the vocabulary data 2131 should have at least one corresponding phonetics data 2111, and each of the sentence data 2141 should have at least one corresponding phonetics data 211, grammar data 2121 and vocabulary data 2131, respectively.

The CPU 22 executes the sentence reading procedure 101, the sentence partition procedure 102, the recombination output procedure 103, the input acceptance procedure 104, the vocabulary data output procedure 105, the grammar data output procedure 106, the phonetics data output procedure 107, the sentence comparison procedure 108, the result output procedure 109 and the result recording procedure 110. The contents of each procedure is similar to the one described in the computer-aided language learning method and is not repeated hereinafter. One should note that the computer-aided language learning system 2 can accept input from the learner in various ways and can output data to the learner through various ways too. For example, the computer-aided language learning system 2 can be a network server and connect to a learner's personal computer through the Internet so as to accept learner's input through devices such as the keyboard, mouse, or sound recognition system and to output text or sound data to the learner through the monitor, speakers or a Braille system. Furthermore, the computer-aided language learning system 2 can be implemented on a portable electronic device such as an electronic dictionary or a personal digital assistant (PDA) without departing from the spirit and scope of the invention.

The grammar data 2121 in the grammar database 212 can have such columns as the grammar code, grammar categories (e.g. nouns, verbs or the sentence), names and definitions. The vocabulary data 2131 in the vocabulary database 213 can have such columns as the code, spellings, variations (e.g. tenses of verbs; singular and plural forms of nouns), phonetic symbols, meanings and attributes. Each word in the first language sentence can correspond to the vocabulary data 2131 in the vocabulary database 213, the grammatical structure can correspond to the grammar data 2121 in the grammar database 212 and the phonetic symbols can correspond to the phonetics data 2111 in the phonetics database 211.

Through the above data structure, the learner can perform cross inquiries about vocabulary, grammar or phonetics at any time when using the computer-aided language learning system 2. Therefore, this system can deliver an integrated environment for practicing vocabulary, grammar and phonetic exercises in the focus language so as to effectively enhance the comprehension and expression abilities of the learner.

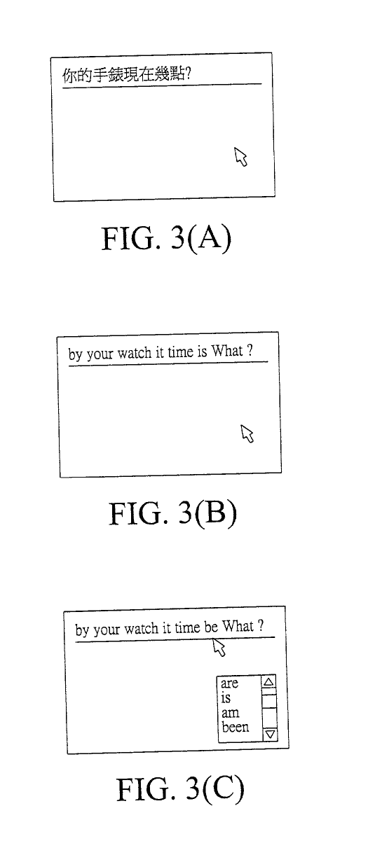

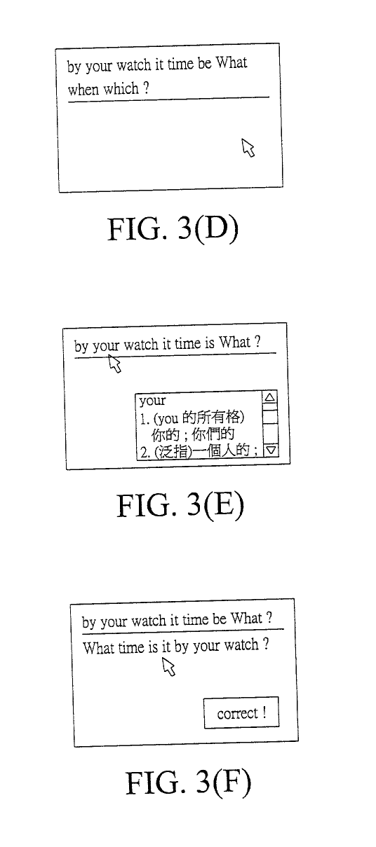

Referring to FIG. 3(A), taking inquiring time as an example, the computer-aided language learning system 2 can first output the second language sentence “What time is it by your watch?” (in Chinese) to the learner. Then, as shown in FIG. 3(B), the system 2 performs the sentence partition procedure and the shuffling process on the first language sentence corresponding to the second language sentence and outputs the result to the learner.

The system can also perform a substitution process on the first language sentence, as shown in FIG. 3(C). For example, the tense of the verb can be changed (from ‘is’ to ‘be’) to increase the difficulty and to make the learner more familiar with the tenses of vocabulary word in question. Or, as shown in FIG. 3(D), the first language sentence is mingled with a few words that have similar properties (adding ‘When’ and ‘Which’, words that are similar to ‘What’) to train the recognition ability of the learner in vocabulary and grammar.

During the process of making a sentence, the learner can ask questions. For example, in FIG. 3(E), when the learner chooses the word ‘your’ and performs a vocabulary inquiry the computer-aided language learning system 2 can retrieve the vocabulary data of ‘your’ from the vocabulary database and output them to the learner. The learner can also enter grammar inquiries or inquiries regarding phonetics to look up relevant grammar data or phonetics data.

After the learner enters the learner-input sentence, the computer-aided language learning system 2 compares it with the first language sentence. If the comparison result indicates a match, then, as shown in FIG. 3(F), the system notifies the learner that his input is correct for his reference.

According to the computer-aided language learning method and system of the invention, the learner can practice vocabulary, grammar and phonetics in an integrated environment so as to effectively increase the comprehension and expression abilities.

According to the computer-aided language learning method and system of the invention, the features of high interactivity between the computer and the learner and of the convenience of computer usage makes language teaching more efficient than conventional language teaching.

According to the computer-aided language learning method and system of the invention, the learner can correctly understand the meaning and equip himself with the ability to freely create and express many types of information by learning vocabulary, grammar, phonetics and complete sentences through choices of answers, recombination and tense changes of sentence elements.

According to the computer-aided language learning method and system of the invention, various choices, recombination and tense changes on the sentence elements can be performed to change the learning styles. Therefore, the difficulty can be gradually increased for advanced learning.

Certain variations would be apparent to those skilled in the art, which variations are considered within the spirit and scope of the claimed invention.

What is claimed is:

1. A computer-aided language learning method, comprising:
a sentence reading procedure for reading in a first language sentence from a computer accessible sentence database;
a sentence partition procedure for performing a sentence element partition sub-procedure on the first language sentence so as to partition the first language sentence into a plurality of sentence elements;
a recombination output procedure for performing a recombination sub-procedure on the sentence elements and outputting the result of the recombination sub-procedure to a learner;
an input acceptance procedure for accepting the data entered by the learner according to the result of the recombination sub-procedure;
a sentence comparison procedure for comparing the learner-input sentence with the first language sentence when the data entered by the learner is a learner-input sentence; and
a result output procedure for outputting the comparison result of the learner-input sentence and the first language sentence to the learner.

2. The method of claim 1, further comprising:
a vocabulary data output procedure for inputting a requested vocabulary data from a computer accessible vocabulary database and outputting the vocabulary data to the learner when the data entered by the learner is a vocabulary inquiry;
a grammar data output procedure for inputting a requested grammar data from a computer accessible grammar database and outputting the grammar data to the learner when the data entered by the learner is a grammar inquiry; and
a phonetics data output procedure for inputting a requested phonetics data from a computer accessible phonetics database and outputting the phonetics data to the learner when the data entered by the learner is a phonetics inquiry.

3. The method of claim 1, further comprising:
a result recording procedure for storing the comparison result of the learner-input sentence and the first language sentence in a statistical data table.

4. The method of claim 1, wherein the recombination sub-procedure includes a shuffling process for the sentence elements.

5. The method of claim 1, wherein the recombination sub-procedure includes a substituting process for the sentence elements.

6. The method of claim 1, wherein the recombination sub-procedure includes a mingling process for the sentence elements.

7. The method of claim 1, wherein
the sentence input procedure further comprises inputting a second language sentence from the sentence database, the meaning of the second language sentence corresponds to that of the first language sentence; and
the recombination output procedure further comprises outputting the second language sentence to the learner.

8. A computer-readable storage medium encoded with executable instructions that can cause a computer to carry out a computer-aided language learning method, the computer-aided language learning method comprising:
a sentence reading procedure for reading in a first language sentence from a computer accessible sentence database;
a sentence partition procedure for performing a sentence element partition sub-procedure on the first language sentence so as to partition the first language sentence into a plurality of sentence elements;
a recombination output procedure for performing a recombination sub-procedure on the sentence elements and outputting the result of the recombination sub-procedure to a learner;
an input acceptance procedure for accepting the data entered by the learner according to the result of the recombination sub-procedure;
a sentence comparison procedure for comparing the learner-input sentence with the first language sentence when the data entered by the learner is a learner-input sentence; and
a result output procedure for outputting the comparison result of the learner-input sentence and the first language sentence to the learner.

9. The computer-readable storage medium of claim 8, wherein the computer-aided language learning method further comprising:
a vocabulary data output procedure for inputting a requested vocabulary data from a computer accessible vocabulary database and outputting the vocabulary data to the learner when the data entered by the learner is a vocabulary inquiry;
a grammar data output procedure for inputting a requested grammar data from a computer accessible grammar database and outputting the grammar data to the learner when the data entered by the learner is a grammar inquiry; and
a phonetics data output procedure for inputting a requested phonetics data from a computer accessible phonetics database and outputting the phonetics data to the learner when the data entered by the learner is a phonetics inquiry.

10. The computer-readable storage medium of claim 10, wherein the computer-aided language learning method further comprising:
a result recording procedure for storing the comparison result of the learner-input sentence and the first language sentence in a statistical data table.

11. The computer-readable storage medium of claim 8, wherein the recombination sub-procedure includes a shuffling process for the sentence elements.

12. The computer-readable storage medium of claim 8, wherein the recombination sub-procedure includes a substituting process for the sentence elements.

13. The computer-readable storage medium of claim 8, wherein the recombination sub-procedure includes a mingling process for the sentence elements.

14. The computer-readable storage medium of claim 8, wherein
the sentence input procedure further comprises inputting a second language sentence from the sentence database, the meaning of the second language sentence corresponds to that of the first language sentence; and
the recombination output procedure further comprises outputting the second language sentence to the learner.

15. A computer-aided language learning system, comprising:
a sentence reading means for reading in a first language sentence from a computer accessible sentence database;
a sentence partition means for performing a sentence element partition sub-procedure on the first language sentence so as to partition the first language sentence into a plurality of sentence elements;
a recombination output means for performing a recombination sub-procedure on the sentence elements and outputting the result of the recombination sub-procedure to a learner;
an input acceptance means for accepting the data entered by the learner according to the result of the recombination sub-procedure;
a sentence comparison means for comparing the learner-input sentence with the first language sentence when the data entered by the learner is a learner-input sentence; and
a result output procedure for outputting the comparison result of the learner-input sentence and the first language sentence to the learner.

16. The system of claim 15, further comprising:
a vocabulary data output means for inputting a requested vocabulary data from a computer accessible vocabulary database and outputting the vocabulary data to the learner when the data entered by the learner is a vocabulary inquiry;
a grammar data output means for inputting a requested grammar data from a computer accessible grammar database and outputting the grammar data to the learner when the data entered by the learner is a grammar inquiry; and
a phonetics data output means for inputting a requested phonetics data from a computer accessible phonetics database and outputting the phonetics data to the learner when the data entered by the learner is a phonetics inquiry.

17. The system of claim 15, further comprising:
a result recording means for storing the comparison result of the learner-input sentence and the first language sentence in a statistical data table.

18. The system of claim 15, wherein the recombination sub-procedure includes a shuffling process for the sentence elements.

19. The system of claim 15, wherein the recombination sub-procedure includes a substituting process for the sentence elements.

20. The system of claim 15, wherein the recombination sub-procedure includes a mingling process for the sentence elements.

21. The system of claim 15, wherein
the sentence input means further inputs a second language sentence from the sentence database, the meaning of the second language sentence corresponds to that of the first language sentence; and
the recombination output means further outputs the second language sentence to the learner.
